(19) United States
(12) Patent Application Publication
(10) Pub. No.: US 2025/0050935 A1
(43) Pub. Date: Feb. 13, 2025

(54) INTUITIVE ELECTRIC STEERING

(71) Applicant: Ariens Company, Brillion, WI (US)

(72) Inventor: Craig Siebert, Neenah, WI (US)

(21) Appl. No.: 18/718,381

(22) PCT Filed: Dec. 9, 2022
(86) PCT No.: PCT/US22/81287

§ 371 Date: Jun. 10, 2024

Related U.S. Application Data
(60) Provisional application No. 63/288,407, filed on Dec. 10, 2021.

(51) Int. Cl. B62D 1/12; B62D 11/00; B62D 11/08

(52) U.S. Cl. CPC B62D 1/12; B62D 11/003; B62D 11/08

(57) ABSTRACT

Systems and methods related to intuitive electric steering for a motor-driven vehicle. One example system includes a first clutch mechanism, a second clutch mechanism, a handlebar for steering the vehicle, and an electronic controller. The first clutch mechanism is configured to control torque power provided to a first wheel on a left side of the motor-driven vehicle. The second clutch mechanism configured to control torque power provided to a second wheel on a right side of the motor-driven vehicle. The handlebar is configured to pivot about an axis. The electronic controller is configured to detect a pressure applied to the handlebar, relative to the axis, by an operator of the motor-driven vehicle. The electronic controller is configured to determine a desired turn direction of the motor-driven vehicle based on the pressure and control the first clutch mechanism and the second clutch mechanism based on the desired turn direction.

### BACKGROUND

Snow blowers, and other motor-driven vehicles, are steered by a user through the use of, among other things, handlebars. In some snow blowers, the operator steers by pushing the handlebars to the right or left, causing the snow blower to steer to the left or right, respectively. Some snowblowers are steered by selectively engaging and disengaging power to two drive wheels.

### SUMMARY

Systems and methods of intuitive electric steering are described herein. In some of the systems and methods described herein, the electric steering is implemented via a hardware configuration that utilizes electromechanical components such as relays and switches to discontinue or reduce power to the clutch(es) to perform the intuitive electric steering, with no electronic controller/processor being necessary. Other systems and methods described herein are directed to utilizing an electronic controller to analyze a plurality of inputs related to one or more characteristics of the unit, determine a particular clutch to disengage based on one or more states of the plurality of inputs, and reduce or discontinue power to the particular clutch.

Intuitive electric steering removes the need for operator intervention during steering and allows the vehicle to steer naturally during normal motion of the vehicle as the respective wheel engagement is automatically adjusted as necessary via a respective clutch mechanism based on forces applied to the handlebars of the vehicle by the operator.

One example provides a system for operating a motor-driven vehicle. The system includes a first clutch mechanism, a second clutch mechanism, a handlebar for steering the vehicle, and an electronic controller. The first clutch mechanism is configured to control torque power provided to a first wheel of the motor-driven vehicle on a left side of the motor-driven vehicle. The second clutch mechanism configured to control torque power provided to a second wheel of the motor-driven vehicle on a right side of the motor-driven vehicle. The handlebar includes a first handle and a second handle and is configured to pivot about an axis. The electronic controller is configured to detect a pressure applied to the handlebar, relative to the axis, by an operator of the motor-driven vehicle. The electronic controller is configured to determine a desired turn direction of the motor-driven vehicle based on the pressure. The electronic controller is configured to control the first clutch mechanism and the second clutch mechanism based on the desired turn direction.

Another example provides a method for operating a motor-driven vehicle. The method includes detecting a pressure applied to a handlebar of the motor-driven vehicle, relative to an axis, about which the handlebar is rotatable. The method includes determining a desired turn direction of the motor-driven vehicle based on the pressure. The method includes controlling a first clutch mechanism configured to control torque power provided to a left wheel of the motor-driven vehicle and a second clutch mechanism configured to control torque power provided to a right wheel of the motor-driven vehicle based on the desired turn direction.

Other aspects of the invention will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a motor driven vehicle according to some embodiments.

FIG. 2 is a is a block diagram of a controller of the vehicle of FIG. 1 according to some embodiments.

FIG. 3A is a flowchart illustrating a method implemented by a controller of FIG. 2 according to some embodiments.

FIG. 3B is a flowchart illustrating a method implemented by a controller of FIG. 2 according to some embodiments.

FIG. 4 is a circuit 400 for implementing the method of FIGS. 3A and 3B absent the controller of FIG. 2, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the examples presented herein are not limited in their application to the details of construction and the arrangement of components set forth in the following description or illustrated in the following drawings. The invention is capable of other embodiments and of being practiced or of being carried out in various ways. For example, while the systems and methods described herein are described in terms of a snowblower, it should be understood that such systems and methods may be applied to other systems such as lawnmowers, tractors, and the like. As another example, while systems and methods described herein are described in terms of an electric motor, such systems and methods may also be applied to other kinds of motors, such as internal combustion engines.

It should be noted that a plurality of hardware and software-based devices, as well as a plurality of different structural components may be utilized to implement the embodiments described herein or portions thereof. In addition, it should be understood that embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects described herein may be implemented in software (stored on non-transitory computer-readable medium) executable by one or more processors. As such, it should be noted that a plurality of hardware and software-based devices, as well as a plurality of different structural components may be used to implement the embodiments described herein. For example, “controller,” “control unit,” “control module,” and “control assembly” described in the specification may include one or more processors, one or more memory modules including non-transitory computer-readable medium, one or more input/output interfaces, and various connections (e.g., a system bus) connecting the components.

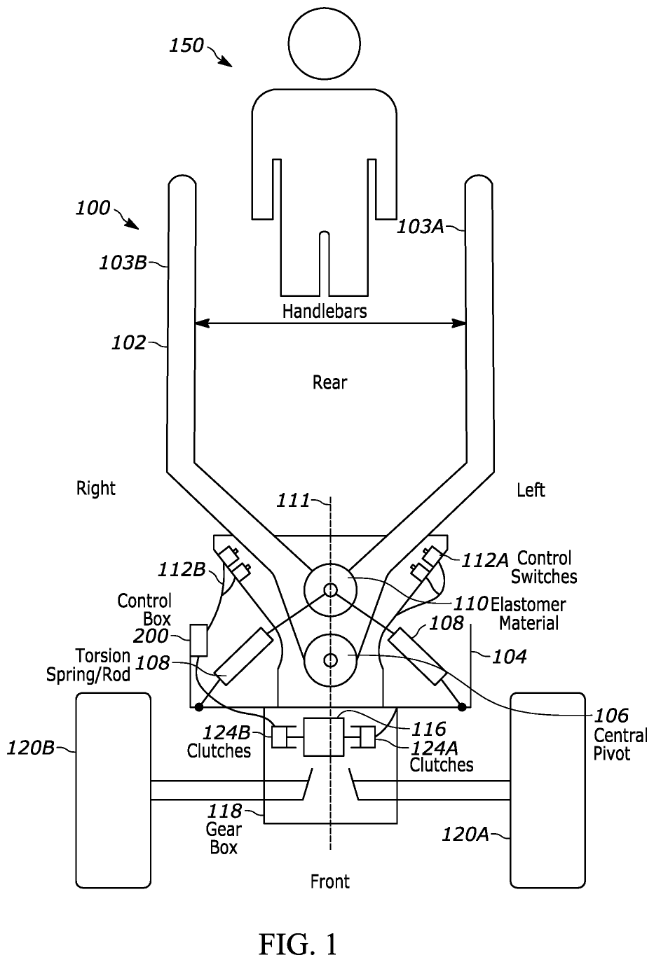

Systems and methods described herein relate to how electromagnetic clutches are engaged and disengaged to produce the desired operation during maneuvering of a motor driven vehicle (such as a snowblower, a lawn mower, or a tractor), based on movement of the handlebar of the vehicle. FIG. 1 is a top-down view diagram of a motor driven vehicle 100 (in the illustrated embodiment, a snowblower). The vehicle 100 includes handlebar 102, which is coupled to a chassis 104 at a single pivot point 106. The handlebar 102 is a unitary handlebar including a left handle 103A and a right handle 103B. In alternative embodiments, the handlebar 102 is comprised of two handles or grips, which each attach to the chassis 104 at its own pivot point. The handlebar 102 is configured to pivot about at least one axis of the pivot point 106. The handlebar 102 is torsion controlled to a center position, for example, using one or more torsion controllers (e.g., the torsion/spring rods 108) and an elastomer structure 110. The torsion/spring rods 108 and the elastomer structure 110 are configured to bias the handlebar 102 to a substantially centered position about the axis (for example, parallel with a longitudinal axis 111 of the vehicle 100) in the absence of pressure applied by an operator 150. The torsion/spring rods 108 and the elastomer structure 110 are further configured to enable the handlebar 102 to move laterally (e.g., side to side) in response to pressure applied on the handlebar 102 by an operator of the vehicle 100.

The vehicle 100 includes rotational position contacts 112A and 112B disposed on a left side and a right side of the pivot point 106, respectively. The contacts 112A and 112B are positioned such that, when the operator 150 applies lateral pressure to the handlebar 102 to rotate it a distance to the left or right of the central position, the handlebar 102 (or a protrusion thereof) makes physical contact with, and thus, actuates, the respective contact 112A, 112B. For example, when the handlebar is rotated to the left of the central position, the handlebar 102 actuates the contact 112A. Likewise, when the handlebar is rotated to the right of the central position, the handlebar 102 actuates the contact 112B. The contacts 112A, 112B may be or include pushbuttons, momentary contact switches, relays, or the like. As described herein, during operation of the vehicle 100, as the operator 150 manipulates the handlebar 102, the controller 200 detects when either of the contacts 112A, 112B have been actuated.

As illustrated in FIG. 1, the handlebar 102 is configured to pivot laterally (i.e., left to right) about a vertical axis of the pivot point 106. In some embodiments, the handlebar 102 is configured to pivot about a horizontal axis (for example, parallel with a longitudinal axis 111 of the vehicle 100), such that an operator of the twist the handlebar (i.e., moving the left handle 103A upward while the right handle 103B is moved downward, and vice versa) about the horizontal axis. In such embodiments, the contacts 112A, 112B are positioned such that they are actuated by the upward or downward movement of the right and left sides of the handlebar 102. In one example, the contacts 112A, 112B are positioned such that they are actuated by the upward movement of the right and left sides of the handlebar 102.

In some embodiments, in which the pivot point 106 enables movement about more than one axis, the torsion/spring rods 108 and the elastomer structure 110 are further configured to enable the handlebar 102 to move along multiple axes in response to pressure applied on the handlebar by an operator of the vehicle 102 and return to the center position when the operator stops applying pressure to the handlebar directed away from the central rotational position.

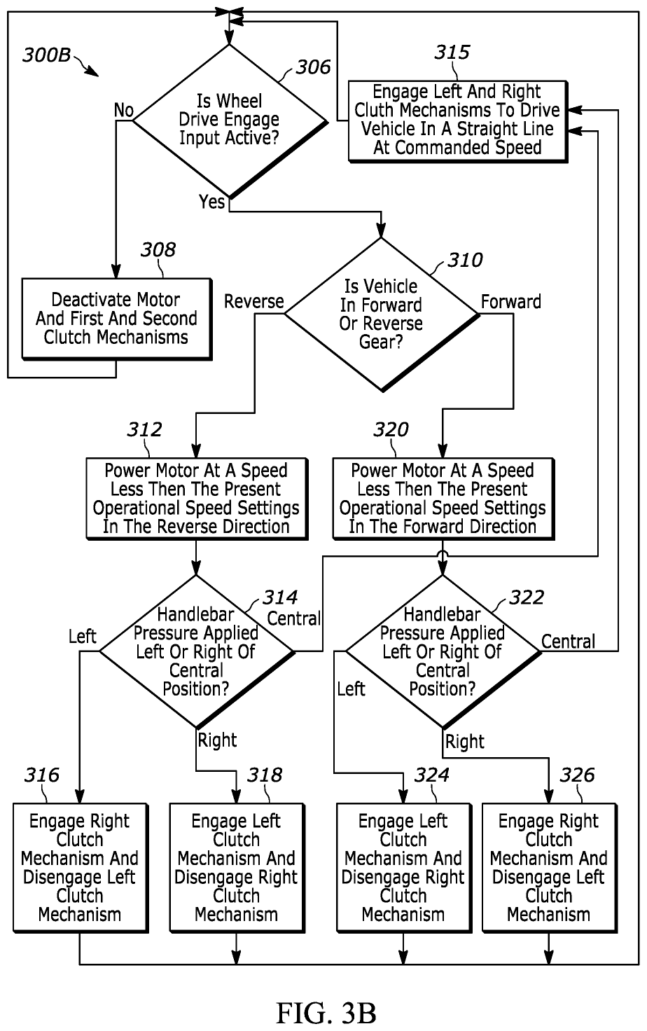

Both rotational positional contacts 112A, 112B are electrically coupled to a controller 200. In some aspects, the controller 200 is electrically coupled to and configured to control a drive motor (e.g., the electric motor 116), as described herein. In some instances, the vehicle 100 is powered by an internal combustion engine. The controller 200 is configured to control power provided to the electric motor 116 (for example, from an electric storage system such as a battery system, which is not shown). In the embodiment illustrated, the electric motor 116 is positioned in a gearbox 118. The electric motor 116 is coupled to and configured to drive a first wheel 120A and a second wheel 120B, as described herein. In the illustrated embodiment, the motor 116 is coupled to the first and second wheels 120A, 120B by a first and a second electromechanical clutch mechanism 124A, 124B, respectively. Each respective electromechanical clutch mechanism 124A, 124B is positioned between the electric motor 116 and the first and second wheels 120A, 120B, respectively, to assist in freewheeling of the vehicle 100. The controller 200, in particular, is configured to provide clutch outputs to control each clutch mechanism 124A, 124B individually as described herein (in particular, with respect to FIGS. 3A and 3B). In particular, the controller 200 is configured to, based on an actuation of a particular contact 112A, 112B, engage the respective clutch mechanism 124A, 124B (i.e. couple the respective clutch mechanism 124A, 124B to the motor 116 via one or more gears, which are not shown, of the gearbox 118 to thus drive the respective wheel 120A, 120B) and/or disengage the respective clutch mechanism 124A, 124B (i.e. decouple the respective clutch mechanism 124A, 124B from the motor 116 via the one or more gears of the gearbox 118, thus not driving the respective wheel 120A, 120B, also known as free-wheeling).

In some instances, controller 200 is configured to default into freewheel mode (i.e., both clutch mechanisms disengaged). This improves operator comfort because pushing a unit that has an electric motor engaged to a gear reduction can be difficult on the operator. The clutch mechanisms allow it to freewheel whenever they are disengaged.

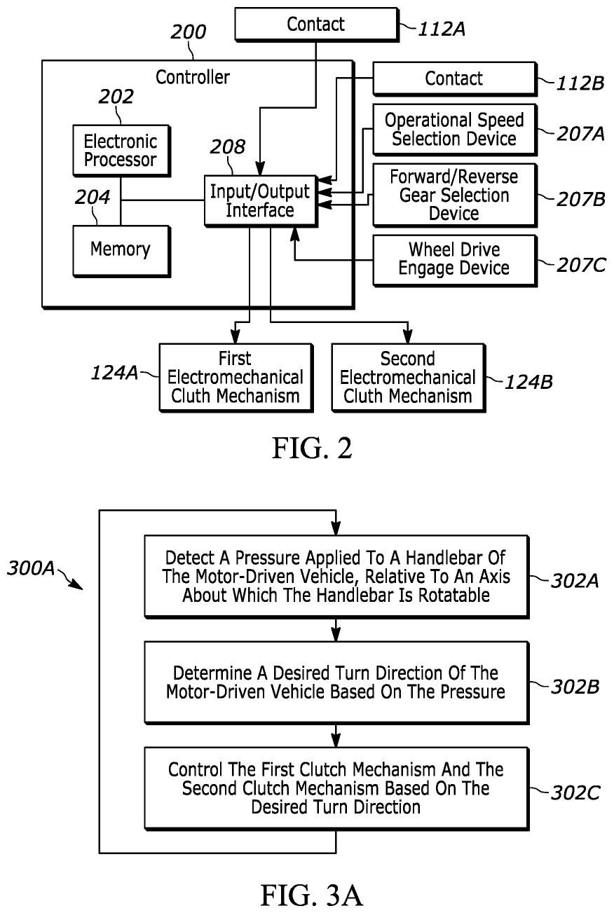

FIG. 2 is a block diagram of the controller 200 according to some examples. In addition to the contacts 112A, 112B, the controller 200 is further configured to receive information regarding an operator-selected operational speed of the motor 116 (i.e. a desired driving speed of the wheels 120A, 120B), information regarding a present gear of the electric motor 116 (i.e. whether the motor is presently in a forward or a reverse gear), and a wheel drive engage setting (i.e., whether the wheels 102A, 102B are set, via a user input, to be engaged to the motor 116 or not). Each of the operational speed information, present gear information, and wheel drive engage setting is obtained by the controller 200 via a suitable analog or digital selection device (selection devices 207A, 207B, and 207C respectively of FIG. 2). The selection device(s) 207A, 207B, and 207C may be a physical switch, knob, slider, button, or other suitable device providing control input to the controller 200. In some embodiments, one or more of the selection devices 207A, 207B, and 207C may be virtual (for example, a graphical user interface element presented on one or more electronic displays by an electronic control module (ECM), vehicle control module (VCM), or similar electronic control unit configured similar to the controller 200). In some embodiments, the selection devices 207A, 207B, and 207C (either physical or virtual) may provide their signals to the controllers 200 via a bus (for example, a CAN bus) or through one or more intervening electronic controllers (for example, a VCM), which are not shown.

In the example illustrated, the controller 200 includes an electronic processor 202 (e.g., a microprocessor, application-specific integrated circuit (ASIC), or another suitable electronic device), a memory 204 (e.g., a non-transitory, computer-readable storage medium), a communication interface 206, and an input/output interface 208. The electronic processor 202, the memory 204, the communication interface 206, and the input/output interface 208 communicate over one or more control and/or data buses (for example, a communication bus). The use of control and data buses for the interconnection between and exchange of information among the various modules and components would be apparent to a person skilled in the art in view of the description provided herein. FIG. 2 illustrates only one example embodiment of the controller 200. The controller 200 may include fewer or additional components and may perform functions other than those explicitly described herein.

In some embodiments, the electronic processor 202 is implemented as a microprocessor with separate memory, for example, the memory 204. In other embodiments, the electronic processor 202 may be implemented as a microcontroller (with memory on the same chip). In other embodiments, the electronic processor 202 may be implemented using multiple processors. In addition, the electronic processor 202 may be implemented partially or entirely as, for example, a field-programmable gate array (FPGA), and application specific integrated circuit (ASIC), and the like and the memory may not be needed or be modified accordingly.

In the example illustrated, the memory 204 includes non-transitory, computer-readable memory that stores instructions that are received and executed by the electronic processor 202 to carry out functionality of the controller 200 described herein. The memory 204 may include, for example, a program storage area and a data storage area. The program storage area and the data storage area may include combinations of different types of memory, for example, read-only memory and random-access memory.

The input/output interface 208 includes one or more input mechanisms such as pushbuttons, knobs, and the like (for example, the contacts 112A, 112B, the operational speed selection device 207A, the forward and reverse selection device 207B, the wheel drive engage device 207C, and the like). The input/output interface 208 may include one or more output mechanisms (for example, a display, a light, a speaker, and the like, which are not shown), or a combination thereof. The input/output interface 208 receives input from one or more components of the controller 200 and/or the vehicle 100 (for example, input devices actuated by an operator of the vehicle 100) and provides output to one or more components of controller 200. The input/output interface may also include one or more sensors (not shown) utilized by the electronic processor 202 to determine one or more states of one or more components of the vehicle 100. In some instances, the input/output interface 208 is electrically coupled to the first and second electromechanical clutch mechanisms 124A, 124B, and controls (along with the electronic processor 202) the operation of the first and second electromechanical clutch mechanisms as described herein.

FIG. 3A illustrates an exemplary method 300A for operating a motor-driven vehicle (e.g., the vehicle 100). It will be appreciated that the method 300A may be modified or performed differently than the specific example provided while still falling within scope of the invention described herein. As an example, the method 300A shown in FIG. 3A is performed by a single controller 200 and, in particular, the electronic processor 202. However, it should be understood that in some embodiments, portions of the method 300A may be performed by additional electronic processors included in the controller 200. For ease of description, the method 500 is described in terms of a single controller 200, a single motor 114, two wheels 120A, 120B, and two respective clutch mechanisms 124A, 124B. It should be understood that the method 300 may be applied to systems including multiple controllers, motors, wheels, and clutch mechanisms.

At block 302A, the electronic processor 202 detects a pressure applied to a handlebar 102 of the motor-driven vehicle 100, relative to an axis about which the handlebar is rotatable. For example, an operator of the motor-driven vehicle 100 may pull the handlebar to the left or right, applying a pressure that causes the handlebar to rotate one way or the other about the axis. The electronic processor 202 may detect the pressure by receiving inputs when one of the contacts 112A, 112B is actuated by the movement of the handlebar 102, as described above. In some aspects, the electronic processor 202 continuously monitors inputs from each of the contacts 112A, 112B to detect changes (e.g., digital high or digital low).

At block 302B, the electronic processor 202 determines a desired turn direction of the vehicle based on the pressure. For example, the electronic processor 202 may determine the desired turn direction of the motor-driven vehicle based by determining whether the pressure is a left pressure or a right pressure. In some instances, the desired turn direction is to the right when the pressure is a left pressure, and the desired turn direction is to the left when the pressure is a right pressure.

At block 302C, the electronic processor 202 controls the first clutch mechanism and the second clutch mechanism based on the desired turn direction. For example, when the desired turn direction is to the right, the electronic processor 202 may engage the first clutch mechanism and disengage the second clutch mechanism, causing the vehicle to move to the right in a forward direction. In another example, when the desired turn direction is to the left, the electronic processor 202 may disengage the first clutch mechanism and engage the second clutch mechanism, causing the vehicle to move to the left in a forward direction.

FIG. 3B is a flowchart illustrating a method 300B for controlling the motor-driven vehicle to operate with intuitive steering. At block 306, the electronic processor 202 determines whether the wheel drive engage input is active/in an on-state (determined based on an input from the wheel drive engage device 207C, for example). In response to the wheel engage input not being active, the motor 116 is deactivated or kept deactivated and neither of the clutch mechanisms 124A, 124B are engaged (block 308). In response to the wheel drive engage input being active, the processor 202 determines, at block 310, whether the vehicle 100 is in a forward gear or in a reverse gear (for example, based on an input from the forward/reverse gear selection device 207B).

When the processor 202 determines that the vehicle 100 is in a reverse gear (i.e., is driving or drivable in a reverse direction), the electronic processor 202, at block 312, controls the motor 116 at a reduced speed that is less than a present operational speed setting (for example, determined from an input from the operational speed selection device 207A). The reduced speed may be, for example, approximately half (i.e., 50%) of the present operational speed setting. At block 314, the electronic processor 202 determines (via the inputs received from the contacts 112A, 112B) whether a left or right pressure is applied to the handlebar 102. In particular, as described above, the electronic processor 202 detects whether one of the contacts 112A, 112B has been actuated, indicating whether the handlebar 102 has been rotated to the left or to the right, respectively. As noted above, in some instance, the handlebar 102 is configured to pivot about a horizontal axis. In one such example, the electronic processor 202 determines that a left pressure has been applied when the contact 112A is actuated by an upward movement of the left handle 103A and determines that a right pressure has been applied when the contact 114A is actuated by an upward movement of the right handle 103B. Whether the left or right pressure is applied to handlebars pivoting about a vertical axis or a horizontal axis, the electronic processor is configured to determine a desired turn direction and operate the clutch mechanisms accordingly (at blocks 314-326).

When a left pressure is detected, the electronic processor 202 determines that the desired turn direction is to the left and thus engages the second clutch mechanism 124B and disengages the first clutch mechanism 124A (block 316). In other words, the wheel 120B on the right side of the vehicle 100 is driven (in a reverse direction) while the wheel 120A on the left side of the vehicle is not driven and spins freely. This results in the vehicle 100, while travelling in reverse, to turn left (causing the front of the vehicle to shift to the right).

When a right pressure is detected, the electronic processor 202 determines that the desired turn direction is to the right and thus engages the first clutch mechanism 124A and disengages the second clutch mechanism 124B (block 318). In other words, the wheel 120A on the left side of the vehicle 100 is driven (in a reverse direction) while the wheel 120B on the right side of the vehicle is not driven and spins freely. This results in the vehicle 100, while travelling in reverse, to turn right (causing the front of the vehicle to respectively shift to the left).

Returning to block 310, when the electronic processor 202 determines that the vehicle 100 is in a forward gear, the electronic processor 202, at block 320, controls the motor 116 at a speed that is according to a present operational speed setting (for example, determined from an input from the operational speed selection device 207A). At block 322, the electronic processor 202 determines whether a left or right pressure is applied to the handlebar 102 (as described above).

When a left pressure is applied, the electronic processor 202 determines that the desired turn direction is to the right and thus engages the first clutch mechanism 124A and disengages the second clutch mechanism 124B (block 324). In other words, the wheel 120A on the left side of the vehicle 100 is driven (in a forward direction) while the wheel 120B on the right side of the vehicle 100 is not driven and spins freely. This results in the vehicle 100, while travelling forward, to turn right (causing the front of the vehicle to respectively shift to the right).

When a right pressure is applied, the electronic processor 202 determines that the desired turn direction is to the left and thus engages the second clutch mechanism 124B and disengages the first clutch mechanism 124A (block 326). In other words, the wheel 120B on the right side of the vehicle 100 is driven (in a forward direction) while the wheel 120A on the left side of the vehicle 100 is not driven and spins freely. This results in the vehicle 100, while travelling forward, to turn left (causing the front of the vehicle to respectively shift to the right).

When the electronic processor 202 determines that the handlebar 102 is neither left nor right of the central rotational position (i.e., neither of the contacts 112A, 112B are actuated), the electronic processor 202 engages both clutch mechanisms 124A, 124B to drive the vehicle in a straight line at the commanded speed (at block 315), and the method 300B repeats (at block 306).

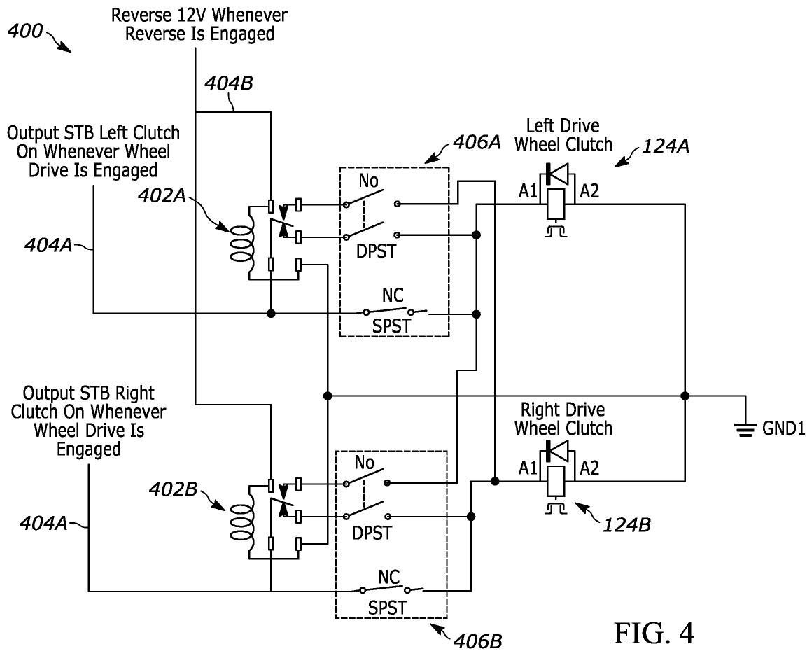

FIG. 4 is an example circuit 400 for implementing the above-described methods 300A, 300B absent the controller 200. In the illustrated example, the circuit 400 includes control circuits 402A and 4002B. Each circuit 402A and 402B is configured to receive a respective input 404A (for example, an active high or active low input), for example, from the wheel drive engage device 207C. Each circuit 402A and 402B is also configured to receive a respective input 404B (for example, an active high or active low input), for example, from the forward/reverse directional selection device 207B, which indicates whether the vehicle 100 is in a forward or reverse direction.

The wheel drive engage device 207C provides a signal, through the input 404A, indicative that the wheel drive engage setting is active. The circuits 402A and 402B are configured such that, while the input 404A indicates that the wheel drive setting is active, the respective clutch mechanisms 124A, 124B are provided with power. Each circuit 402A, 402B is also configured such that when the signal from the input 404B is high, that the current provided through the switches is reduced, thus reducing the amount of power provided to the respective clutch mechanism 124A, 124B and therefore causing the respective wheels 120A, 120B to operate, in reverse, at a speed slower than the present operational speed setting.

Each circuit 402A and 402B include a plurality of switches 406A, 406B. Each of the plurality of switches 406A, and 406B include one of the contacts 112A, 112B, respectively. As explained above, the contacts 112A, 112B are actuated in response to being contacted by the handlebar 102 when the handlebar 102 is rotated to a certain extent from the center rotational position. Upon actuation of either of the contacts 112A, 112B, one or more of the switches 406A, 406B are flipped or opened based on, also, the inputs 404A and 404B.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various features and advantages of the invention are set forth in the following claims.

What is claimed is:

1. A system for operating a motor-driven vehicle, the system comprising:
a first clutch mechanism configured to control torque power provided to a first wheel of the motor-driven vehicle on a left side of the motor-driven vehicle;
a second clutch mechanism configured to control torque power provided to a second wheel of the motor-driven vehicle on a right side of the motor-driven vehicle;
a handlebar for steering the motor-driven vehicle, the handlebar including a first handle and a second handle, and configured to pivot about an axis; and
an electronic controller configured to:
detect a pressure applied to the handlebar, relative to the axis, by an operator of the motor-driven vehicle;
determine a desired turn direction of the motor-driven vehicle based on the pressure; and
control the first clutch mechanism and the second clutch mechanism based on the desired turn direction.

2. The system of claim 1, wherein the electronic controller is further configured to:
determine the desired turn direction of the motor-driven vehicle based on the pressure by determining whether the pressure is a left pressure or a right pressure,
wherein the desired turn direction is to the right when the pressure is a left pressure and the desired turn direction is to the left when the pressure is a right pressure.

3. The system of claim 2, wherein the electronic controller is further configured to:
responsive to determining that the desired turn direction is to the right, control the first clutch mechanism and the second clutch mechanism by engaging the first clutch mechanism and disengaging the second clutch mechanism.

4. The system of claim 2, wherein the electronic controller is further configured to:
responsive to determining that the desired turn direction is to the left, control the first clutch mechanism and the second clutch mechanism by disengaging the first clutch mechanism and engaging the second clutch mechanism.

5. The system of claim 2, wherein the electronic controller is further configured to:
determine the desired turn direction based further on whether the motor-driven vehicle is driving in a reverse direction;
wherein, when the motor-driven vehicle is driving in a reverse direction, the desired turn direction is to the left when the pressure is a left pressure and the desired turn direction is to the right when the pressure is a right pressure.

6. The system of claim 5, wherein the electronic controller is further configured to:
responsive to determining that the desired turn direction is to the right, control the first clutch mechanism and the second clutch mechanism by engaging the first clutch mechanism and disengaging the second clutch mechanism.

7. The system of claim 5, wherein the electronic controller is further configured to:
responsive to determining that the desired turn direction is to the left, control the first clutch mechanism and the second clutch mechanism by disengaging the first clutch mechanism and engaging the second clutch mechanism.

8. The system of claim 5, wherein the electronic controller is further configured to:
responsive to determining that the motor-driven vehicle is driving in a reverse direction, control a drive motor of the motor-driven vehicle to operate at a reduced speed.

9. The system of claim 1, further comprising:
a torsion controller coupled between the handlebar and a chassis of the vehicle, the torsion controller configured to bias the handlebar to a central position relative to the axis.

10. The system of claim 1, wherein the first handle and the second handle are configured to pivot about the same axis.

11. The system of claim 10, wherein the axis is either a horizontal axis or a vertical axis.

12. The system of claim 1, wherein the first handle is configured to pivot about a first axis and the second handle is configured to pivot about a second axis different from the first axis.

13. A method for operating a motor-driven vehicle, the method comprising:
detecting a pressure applied to a handlebar of the motor-driven vehicle, relative to an axis about which the handlebar is rotatable;
determining a desired turn direction of the motor-driven vehicle based on the pressure; and
controlling a first clutch mechanism configured to control torque power provided to a left wheel of the motor-driven vehicle and a second clutch mechanism configured to control torque power provided to a right wheel of the motor-driven vehicle based on the desired turn direction.

14. The method of claim 13, wherein:
determining the desired turn direction of the motor-driven vehicle based on the pressure includes determining whether the pressure is a left pressure or a right pressure, and the desired turn direction is to the right when the pressure is a left pressure and the desired turn direction is to the left when the pressure is a right pressure.

15. The method of claim 14, wherein:
when the desired turn direction is to the right, controlling the first clutch mechanism and the second clutch mechanism includes engaging the first clutch mechanism and disengaging the second clutch mechanism.

16. The method of claim 14, wherein:
when the desired turn direction is to the left, controlling the first clutch mechanism and the second clutch mechanism includes disengaging the first clutch mechanism and engaging the second clutch mechanism.

17. The method of claim 14, further comprising:
determining the desired turn direction based further on whether the motor-driven vehicle is driving in a reverse direction; and
when the motor-driven vehicle is driving in a reverse direction, determining that the desired turn direction is to the left when the pressure is a left pressure and the desired turn direction is to the right when the pressure is a right pressure.

18. The method of claim 17, wherein:
when the desired turn direction is to the right, controlling the first clutch mechanism and the second clutch mechanism includes engaging the first clutch mechanism and disengaging the second clutch mechanism.

19. The method of claim 17, wherein:
when the desired turn direction is to the left, controlling the first clutch mechanism and the second clutch mechanism includes disengaging the first clutch mechanism and engaging the second clutch mechanism.

20. The method of claim 17, wherein, when the motor-driven vehicle is driving in a reverse direction, controlling a drive motor of the motor-driven vehicle to operate at a reduced speed.
